(19) United States
(12) Patent Application Publication
(10) Pub. No.: US 2002/0133749 A1
(43) Pub. Date: Sep. 19, 2002

(54) System and method for managing and implementing electronic equipment tests

(76) Inventors: Michael B. Petersen, St. Charles, IL (US); Steven T. Robbins, St. Charles, IL (US)

Correspondence Address: Mr. Marc D. Machtinger, Esq., Law Office of Marc D. Machtinger, Ltd., Suite 350, 750 W. Lake Cook Road, Buffalo Grove, IL, 60089-2073, US

(21) Appl. No.: 09/996,972

(22) Filed: Nov. 20, 2001

Related U.S. Application Data
(60) Provisional application No. 60/265,384, filed on Jan. 30, 2001.

(51) Int. Cl. G06F 11/26

(52) U.S. Cl. 714/27

(57) ABSTRACT

A system and method for managing and implementing tests for electronic equipment having a host device having a database containing selectable test options, a remote device to which information from the host device is downloaded, the information including at least one test selection, the remote device being capable of implementing a test protocol corresponding to the test selection by interfacing with and controlling testing equipment. The system optionally allows for the host to contain a database including identifiers for electronic equipment, and for the information to contain an equipment selection. Test results are optionally recorded and analyzed. An alternate embodiment of the system and methods integrates the functions of the host and remote device into a single device, either host or remote, and provides for wired, wireless, or network connection between the device and the testing equipment.

### CROSS-REFERENCE TO RELATED APPLICATIONS

This application claims the benefit of U.S. Provisional Application No. 60/265,384, filed Jan. 30, 2001, which is hereby incorporated by reference herein in its entirety.

### TECHNICAL FIELD

The present invention relates to a system and method for managing and implementing electronic equipment tests, and more specifically to a system and method for selecting test options on a host device, downloading information to a remote device, and using the remote device to control testing equipment, or alternatively performing these functions using a single host or remote device.

### BACKGROUND OF THE INVENTION

Typically, when electronic equipment must be tested, a technician is dispatched to the site along with particular testing equipment. Testing equipment varies substantially. The technician manually controls the testing equipment in order to implement tests of the electronic equipment. This requires a great deal of knowledge on the part of the technician, and leaves much room for error. Such problems are significant in industries which require a great variety of tests to be conducted on a variety of electronic equipment. For example, the communications industry is particularly prone to such problems.

Several systems for testing electronic devices have been proposed. For example, U.S. Pat. No. 5,884,202, issued to Arjomand, discloses a diagnostic test system particularly for the auto repair industry. This system includes a control module which interfaces with testing equipment to perform tests on various auto components. The system lacks any remote unit for interfacing with multiple types of testing equipment. Furthermore, tests must be individually conducted via the control unit.

U.S. Pat. No. 6,064,721, issued to Mohammadian et al., discloses a test instrument having two components which together form a test set unit. The first component controls the second, which interfaces with the circuit. Multiple types of testing equipment cannot be used, and no centralization for selecting tests and equipment or collecting results exists.

A single testing instrument is disclosed by U.S. Pat. No. 5,511,108, issued to Severt et al. This unit allows for controlling and interfacing to a circuit in a single instrument. Again, multiple types of testing equipment cannot be used, and no centralized control for multiple projects exists.

It would be of great advantage to provide a system and method for allowing for centralized management of tests on electronic equipment, the capability to interface with multiple types of testing equipment, and the ability to collect and analyze results from an array of tests.

### SUMMARY

In view of the insufficiencies discussed above, it is an object of the present invention to provide an improved system and method for managing and implementing electronic equipment tests.

In accordance with the above objectives, a system and method are disclosed which address the above identified problems.

As used herein, the terms “electronic equipment” are used to refer to any type of electronic equipment capable of testing, whether individual components, circuits, electronic systems, or combinations of technologies containing electronic or electrical components. Such equipment may be related to any industry, including but not limited to the communications industry, the automotive industry, the medical technology industry, or any other industry which utilizes electronic equipment. The terms “identifiers for electronic equipment” are used herein to indicate any reference name, number, icon, or other symbol or set of symbols which can be used to identify particular electronic equipment.

All connections, whether between host and remote devices, remote and testing equipment, host and testing equipment, etc., may be wired, wireless, LAN, modem, cellular modem, wireless, BLUETOOTH™ wireless, internet, or any other suitable manner of interfacing.

Testing criteria for parametric testing can be modified based on experience incorporating information from test results.

The system and method of the present invention can generally be described as follows. A host device is utilized which is operated by a central operator. The host device comprises a user interface which allows the operator to select from various test options. The test options may be arranged such that the operator first selects a circuit identifier, or identifier for electronic equipment. The operator can then determine what testing equipment is available for use and make a selection based on such availability. Then, various tests or test sequences are selected. A module for translating the tests or test sequences translates the information such that it can be implemented for the appropriate testing equipment.

Once the selections are made, the information is downloaded to a remote device, such as a PC or palm-sized device. The remote device can then be taken on site and interfaces with the particular testing equipment available. The remote device then controls the testing equipment to implement the selected test or test sequence. Once the test is performed, data is collected by the remote device corresponding to the results of the test or tests performed. This data may be uploaded to a centralized database for storage and analysis. The centralized database is ideally maintained within the host device.

The system of the present invention has the advantages of allowing central management of the implementation of various tests, reduces the skill level required of technicians operating the testing equipment, and reduces the risk of human error. An alternate embodiment of the present invention allows for all of the above functionality to be performed using a single device, i.e., either a host or server device or a remote device.

Other features and advantages of the invention will be apparent from the following detailed description taken in conjunction with the following drawings.

### BRIEF DESCRIPTION OF THE DRAWINGS

FIG. 1 is a conceptual view of the system of the present invention.

FIG. 2 is a conceptual view of the step of entering information regarding availability of equipment into the host device of the present invention.

FIG. 3 is a conceptual view of a preferred embodiment of the system and method of the present invention.

FIG. 4 is a conceptual view of a preferred embodiment of the implementation of tests and uploading of information according to the present invention.

FIG. 5 is a conceptual view of an alternate embodiment of the entry of equipment availability information of the present invention.

FIG. 6 is a conceptual view of a direct host to testing equipment mode of operation of the present invention.

FIG. 7 is a conceptual view of an alternate embodiment including parametric operation of the present invention.

FIG. 8 is a conceptual view of a further embodiment and mode of operation of the present invention.

FIG. 9 is a conceptual view of a further embodiment showing operation between a remote device and testing equipment according to the present invention.

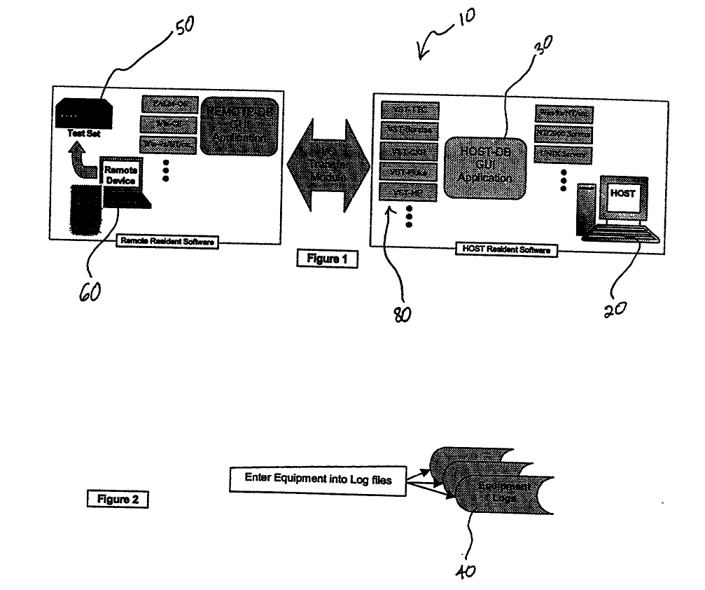

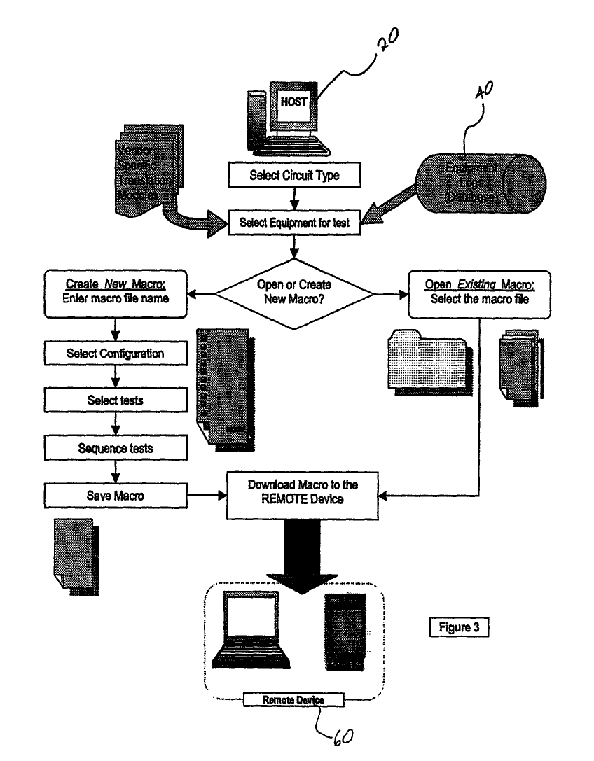

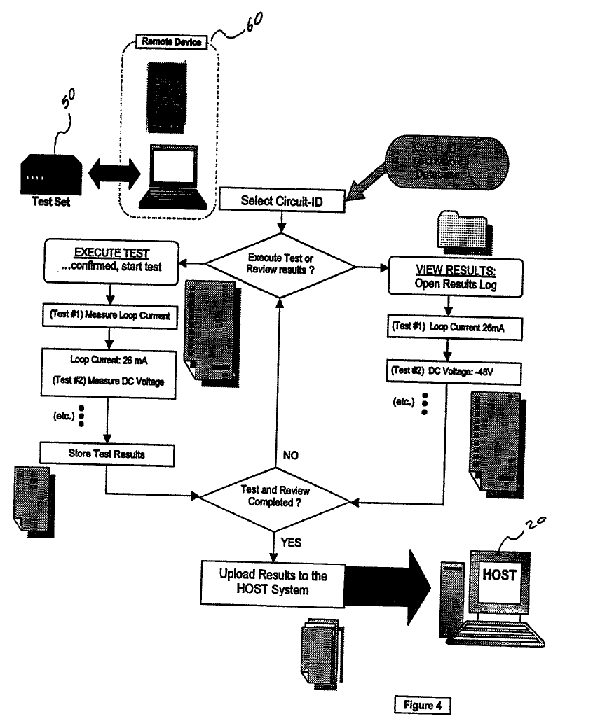

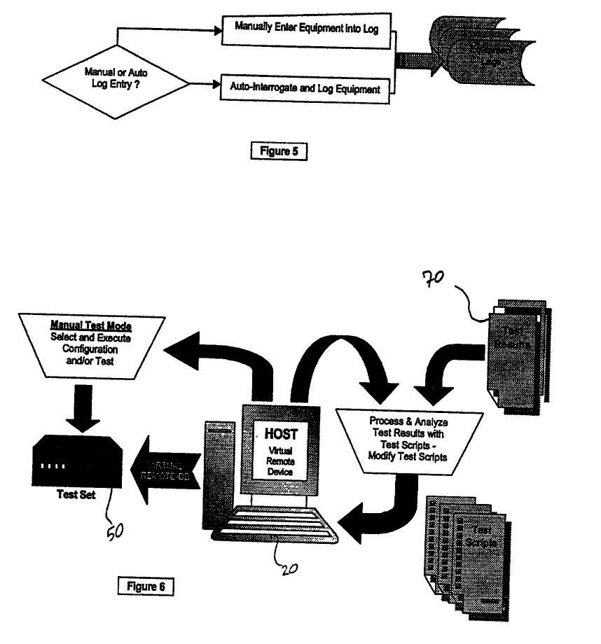

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention comprises a system 10 and method for managing and implementing tests for electronic equipment. As used herein, the term “tests” is to be construed broadly, and encompasses the implementation of a single instruction or sequence of instructions, as well as an instruction to merely monitor a circuit or condition. The result of the “test” may be merely an output from the equipment which can be measured, or a functional reconfiguration of the equipment such as the programming of a VCR.

A host device 20 having a database containing selectable test options is provided. The host device 20 is preferably a desktop computer, mainframe computer, server, or any other suitable computer or network capable of implementing the software modules according to the present invention. The device 20 would include a graphic user interface 30. The system preferably operates in a WINDOWS, NT, UNIX, LINUX, HTML, or other suitable based environment.

An operator of the host device 20 performs various initial steps to configure the system. Available equipment information is entered into a database or into log files 40 of the host device 20 to indicate what types of testing equipment 50 are available. The operator selects a circuit ID or identifier for electronic equipment. The operator can then view what types of testing equipment 50 are available which are capable of testing the selected electronic equipment. After selecting testing equipment 50, the operator then selects what test or tests will be conducted, and optionally selects the sequence for such tests. All of these selections are referred to herein as “test options.”

The tests, test steps, or test sequences are converted to communication sequences which are specific to the selected testing equipment 50. This translation preferably is implemented via vendor specific translation modules 80.

Once the test options have been selected, a remote device 60 is selected. Alternatively, a default remote device 60 can be presumed. Remote device 60 can be any suitable computing device, preferably a desktop, portable PC, laptop, tablet or palm-sized device, or other suitable computing device. The remote device operates within any suitable environment such as WINDOWS, NT, CE (WINDOWS 95, 98, NT, CE), UNIX, HTML, LINUX, PALM OS, etc. The test options, including the circuit ID, are downloaded to the remote device 60. The downloading process can be wired, wireless, over a network such as the Internet or other network, or by any suitable connection. Information for single or multiple jobs can be downloaded to a given remote device 60. Such information may include any or all of the following: test information, test options, a test selection, an equipment selection, configuration instructions or parameters for configuring test equipment, status information such as line status, alarm status, status of events, and test result categories or parameters. Once the information has been transferred to the remote device 60, a technician can transport the remote device 60 to the site of the electronic equipment to be tested. The remote device is then interfaced to the testing equipment 50 via wired or wireless connection. The testing equipment 50 is installed to the electronic equipment to be tested. The technician then interfaces with the remote device 60 via a graphic user interface to select the appropriate circuit ID, and executes the test sequences to be performed.

In a preferred embodiment, the test results 70 are logged into the remote device 60. Preferably, the information logged is associated with the appropriate circuit ID, and includes the date and time of the test, the testing equipment configuration and ID, the test or tests performed, and the results of those tests. This test result information is preferably uploaded into a centralized database for storage and analysis. In a preferred embodiment, the centralized database is located on the host device 20. These results can be cross-referenced, and tabulated to identify common failures, trends, remedies, and other information. This information can be integrated to optimize test sequences and diagnosis.

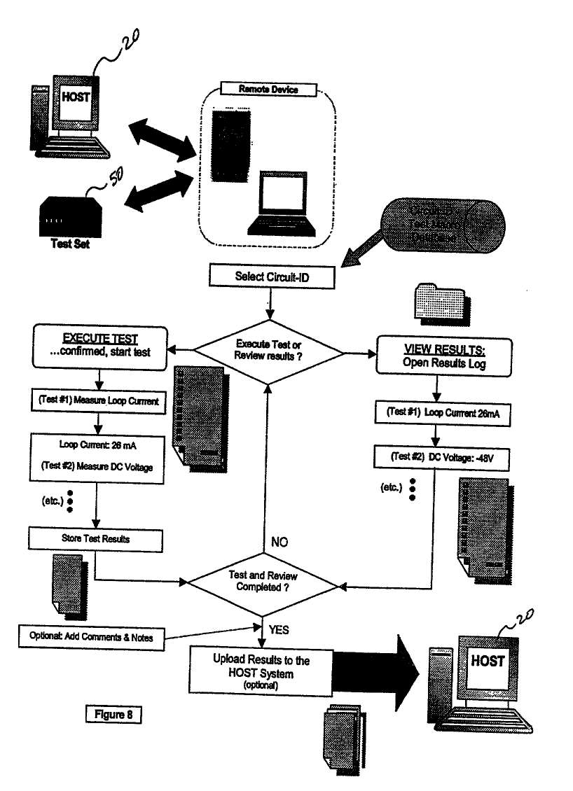

In another preferred embodiment of the present invention illustrated in FIG. 7, parametric testing procedures can be implemented. Various parameters can be entered, such as pass/fail parameters for various tests. General pass and fail indications can be recorded, or, in one preferred embodiment, specific failure information can be recorded. The technician is optionally guided to continue, halt, or request assistance. Assistance can be requested via a connection to the host device 20. Thus, operators with expertise need only be utilized when difficulties are encountered.

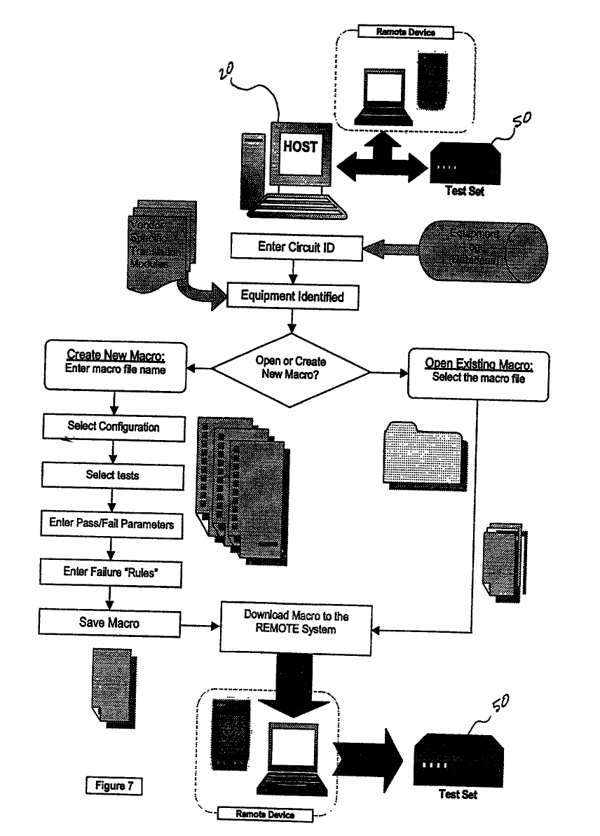

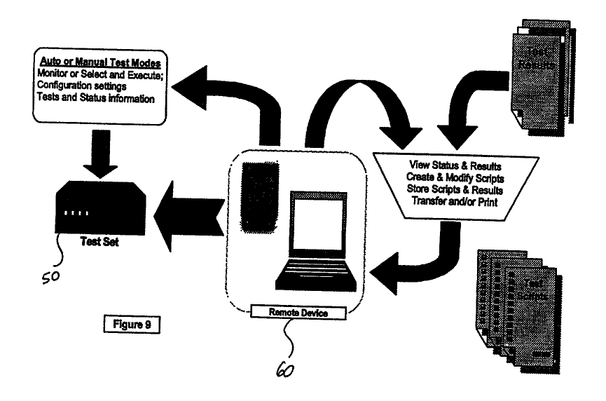

In a further preferred embodiment of the present invention (see FIGS. 6-8), the host device 20 can control the testing equipment directly by any suitable wired, networked, or wireless connection, and either by passing through the remote device 60 or directly connecting to the testing equipment 50. Such a mode may be desirable if a test produces a failing result and further diagnosis becomes necessary.

In an alternate embodiment of the present invention, logical rules based testing can be implemented in such a manner that further tests, detailed analysis, or both, are automated when specific tests produce failing results. Such tests or analysis can be either manually implemented or automated, and allow for specific diagnosis of a given failure. Once an initial test produces the failing result, further subordinate tests can be implemented in order to complete the diagnosis.

In another embodiment of the present invention, all of the functionality described above can be implemented in a single device. This device may be the host or server device, or, it may be the remote device. If the host device is used, the host device may directly interface with the testing equipment via wired connection, wireless connection, network or internet connection. Similarly, if the remote device is used for all functionality, the remote device would interface directly with the testing equipment via wired connection, wireless connection, network or internet connection. The remote device is any suitable computing system, however, is preferably a laptop or notebook computer or hand held device such as a Palm or PDA system.

In this single device embodiment, the system would comprise a device having a database containing selectable test options wherein selections can be made by a user via a user interface, said selections comprising at least one test selection, said device being capable of implementing a test protocol corresponding to said test selection by interfacing with and controlling testing equipment. The device preferably contains a database containing selectable identifiers for electronic equipment, and the selections preferably comprise at least one equipment selection. This system would include a graphic user interface module which allows a user to interface with the databases and to select from the identifiers for electronic equipment and the test options. Furthermore, the device preferably includes a database containing selectable testing equipment options.

As in the previous embodiments, this single device embodiment preferably includes translation modules for translating testing steps into communication sequences specific to particular testing equipment. The device optionally includes means for recording and storing results from one or more tests, and optionally includes means for analyzing the results.

Each of the functions in the single device embodiment can be utilized in the method of the present invention using a single host or remote device.

While the specific embodiments have been illustrated and described, numerous modifications come to mind without significantly departing from the spirit of the invention, and the scope of protection is only limited by the scope of the accompanying claims.

What is claimed is:

1. A system for managing and implementing tests for electronic equipment comprising:
a host device having a database containing selectable test options,
a remote device to which information from the host device is downloaded, said information comprising at least one test selection, said remote device being capable of implementing a test protocol corresponding to said test selection by interfacing with and controlling testing equipment.

2. The system according to claim 1, wherein the host device further comprises a database containing selectable identifiers for electronic equipment, and wherein said information further comprises at least one equipment selection.

3. The system according to claim 2, wherein said host device further comprises a graphic user interface module which allows a user to interface with said databases and to select from said identifiers for electronic equipment and said test options.

4. The system according to claim 3, wherein said host device further comprises a database containing selectable testing equipment options.

5. The system according to claim 2, further comprising translation modules for translating testing steps into communication sequences specific to particular testing equipment.

6. The system according to claim 1, wherein said information is downloaded via a wired connection.

7. The system according to claim 1, wherein said information is downloaded via a wireless connection.

8. The system according to claim 1, wherein said information is downloaded via a computer network.

9. The system according to claim 1, wherein said remote device further comprises means for recording results from a test, and further comprising means for uploading said results to said host device.

10. The system according to claim 9, wherein said host device further comprises means for analyzing said results.

11. A method for managing and implementing tests for electronic equipment comprising the steps of:
selecting at least one test option using a host device,
downloading information comprising at least one test selection to a remote device,
having an operator interface said remote device to testing equipment to test particular electronic equipment.

12. The method according to claim 11, further comprising the step of:
selecting at least one identifier for electronic equipment using the host device, and wherein said information further comprises at least one electronic equipment selection.

13. The method according to claim 12, further comprising the steps of:
recording the results of a test using the remote device,
uploading the results of the test from the remote device to a central database.

14. The method according to claim 13, wherein the central database is contained on the host device.

15. The method according to claim 13, further comprising the step of:
analyzing and managing the results of the test using the central database.

16. The method according to claim 13, wherein said results comprise a circuit identifier, a test time, a test set configuration, and a test step.

17. The method according to claim 11, further comprising the steps of:
performing at least one subordinate test via said remote device in response to a failing result from a test step.

18. The method according to claim 17, wherein results from the at least one subordinate test are used to determined a specific cause of failure.

19. The method according to claim 11, further comprising the steps of:
providing an option to the operator when a failing result from a test step arises to continue or discontinue testing.

20. The method according to claim 19, wherein the step of providing an option to the operator further comprises providing an option to interface with said host device to complete testing.

21. The method according to claim 20, wherein the host device interfaces directly with the testing equipment.

22. A system for managing and implementing tests for electronic equipment comprising:
a device having a database containing selectable test options wherein selections can be made by a user via a user interface, said selections comprising at least one test selection, said device being capable of implementing a test protocol corresponding to said test selection by interfacing with and controlling testing equipment.

23. The system according to claim 22, wherein the device further comprises a database containing selectable identifiers for electronic equipment, and wherein said selections further comprise at least one equipment selection.

24. The system according to claim 23, wherein said device further comprises a graphic user interface module which allows a user to interface with said databases and to select from said identifiers for electronic equipment and said test options.

25. The system according to claim 24, wherein said device further comprises a database containing selectable testing equipment options.

26. The system according to claim 23, further comprising translation modules for translating testing steps into communication sequences specific to particular testing equipment.

27. The system according to claim 22, wherein said device is a host or server device capable of interfacing with testing equipment via wired, wireless, network, or internet connection.

28. The system according to claim 22, wherein said device is a remote device capable of interfacing with testing equipment via wired, wireless, network, or internet connection.

29. The system according to claim 22, wherein said device further comprises means for recording results from a test.

30. The system according to claim 29, wherein said device further comprises means for analyzing said results.

31. A method for managing and implementing tests for electronic equipment comprising the steps of:
selecting at least one test option using a device,
said test option comprising at least one test selection,
interfacing said device to testing equipment to test particular electronic equipment.

32. The method according to claim 31, further comprising the step of:
selecting at least one identifier for electronic equipment using the device, and
selecting at least one electronic equipment selection.

33. The method according to claim 32, further comprising the steps of recording the results of a test using the device.

34. The method according to claim 32, further comprising the step of:
analyzing and managing the results of the test using a central database.

35. The method according to claim 32, wherein said results comprise a circuit identifier, a test time, a test set configuration, and a test step.

36. The method according to claim 31, further comprising the steps of:
performing at least one subordinate test via said device in response to a failing result from a test step.

37. The method according to claim 36, wherein results from the at least one subordinate test are used to determined a specific cause of failure.

38. The method according to claim 31, further comprising the steps of:
providing an option to the operator when a failing result from a test step arises to continue or discontinue testing.

39. The method according to claim 31, wherein the device is a host or server device capable of interfacing with the sting equipment via wired, wireless, network, or internet connection.

40. The method according to claim 31, wherein the device is a remote device capable of interfacing with testing equipment via wired, wireless, network, or internet connection.

41. The system according to claim 28, wherein said remote device is a PDA or Palm device, and wherein said testing equipment comprises telecommunications testing equipment.

42. The system according to claim 28, wherein said remote device is a PDA or Palm device, and wherein said testing equipment comprises transmissions testing equipment.
